(19) United States
(12) Patent Application Publication
(10) Pub. No.: US 2007/0226874 A1
(43) Pub. Date: Oct. 4, 2007

(54) Whiskler

(76) Inventor: Tabatha D. Cain, Bennettsville, SC (US)

Correspondence Address: Tabatha D. Cain, 307 N. Weatherly St., Bennettsville, SC, 29512, US

(21) Appl. No.: 11/712,141

(22) Filed: Feb. 28, 2007

Related U.S. Application Data
(60) Provisional application No. 60/779,125, filed on Mar. 3, 2006.

(51) Int. Cl. A41D 19/00

(52) U.S. Cl. 2/159

(57) ABSTRACT

An embellish property apparel, personal attire for protecting the hands when performing numerous hairs purposes especially in grooming all types of hairs textures of mankind and pets, animals, etc. The embellish apparel property is uniquely designed. Not to perform as your ordinary gloves or any other hair supplies. All its function parts have duty's and they woven together as one unit and at the same time protect the hands from all sorts of damaging procedures such as coloring dyes, pestilence (lice) perming and yes, even texturizing, stain fingernails, brittle nails of that nature. We all know brushing the hair at least once a day removes germs and many other diverse particles. The apparel was given to me by God. It consists of a 7 in 1 product. The apparel is made completely of rubberish material that is durable. All fingertips are covered with brissels at the tip of each finger. Then there are brissels in the palm of the glove apparel which are in a circular shape if you will, to help provide the detanglement and power reaching area that the hand and fingernails may not be able to reach or perform. Massage can occur when moving the apparel glove in the circular motion. Grippers help pull apparel on the hand correctly without tearing or struggle. The Velcro wrist band which provides a block barrier to keep unwanted chemicals substances germicides, water that is unwanted out of the glove. Especially those unwanted invisible parasites. It is very evident that this apparel will show itself to be conventional and economical friendly, wise. When meeting people the first thing they notice is your hair, teeth, eyes, nails and hands. Germs are America's number one concern.

### BACKGROUND OF THE INVENTION

The invention helps in big or small hair procedure of all sorts. The current invention relates and tell you about, it's members and how the glove member parts work together. The glove itself is the ambassador of all glove it detangles and helps in all areas of grooming any types of hair procedures. The glove get's rid of unwanted germs and pestilence in hairs of Animals and mankind as well. It is mainly made up of rubberish material that has to be durable which will protect all parts of the hand especially keeping nails healthy, clean, and keeping nails from being brittle etc. It especially protects from germs. The product will also benefit especially from the environmental situations, such as oil spills and national disasters of all sorts. When the product was conceived I knew consumers, Barber Shops, Beauty Salons, Pet Salons, shall really benefit as well. The glove has a main home base imbedded in the palm of the glove this is called the (home base) main brissels and it's other members of the glove which are the fingertips and each finger tip have brissels on the glove and in the fingertip are brissels in the inner of the fingertip, and the third of the fingertips is covered at the fingertips. Brissels as the homebase is the main brissel station if you will when providing the grooming and Whiskling relationship by letting them work together even the added features which are as follows grippers to help you pull up the glove on the hand correctly. Velcro wristband keeps water germs, pestilence, and other unwanted substances, etc. out.

### Function of the Described Parts

1. Glove—Covers the hands and is a protector of the hand and the fingers providing protection from unwanted substances, parasites germs etc. especially chemicals. Covering each finger including the thumb in separate sections.
2. Grippers—Grippers are added as helpers, they are stripes of hard rubber to help pull up the glove correctly they are located on the left side and right side below main brissels (home base) (see number 5) of drawings on FIG. 1 grippers help when pulling glove on, no struggle will occur. Grippers help prevent tearing.
3. Velcro Wristband—A water substance, germicide hairs, parasites etc. blocker if you will that prevents unwanted visible or invisible compounds substances from entering inside the glove. See number 3. of drawings on FIG. 1.
4. Brissels—The main members that make up the whiskler glove tiny teeth that perform hair duties and they are located on the fingers and thumb of the glove. Also in the palm (center of the glove). Brissels detangles, remove hair build up and other particles. Etc. The fingertips have brissels located in the center of the fingertips, thumb as well have brissels in the center of the fingertips. See diagram FIG. 3 of WGD Model.
5. Main Brissel—The brissels located in the center (palm middle) of the glove is the power of the glove. Circular shape, brissels imbedded in the palm, middle are inside the cylinder and it is called the home base. See drawing no. 1 and no. 5.
6. Glove Exterior—The gloves entire make—up if you will the whole body of the glove is made of rubberish durability material and can be recycled. See drawings FIG. 5.
7. Fingertips—Brissels are located on the fingertips and a third of the fingers of the glove and thumb, the glove and its members will operate as a unit. Fingertips brissels will provide help to the home base of the glove, especially in the detanglement and the other hair duties, procedures.

### BRIEF DESCRIPTION OF THE SEVERAL VIEWS OF DRAWINGS

FIG. 1. The diagram or drawings on this FIG. 1 shows the Whiskler without one main detail.

FIG. 2. The diagram shows the actual Whiskler from a straight forward look. See diagram.

FIG. 3. Shows a complete side figure of the Whiskler Glove.

FIG. 4. This page is the main blue print of all the working parts of the glove and when added together you get the finished invention from drawing on FIG. 3 page. See drawings.

FIG. 5 The diagram on this page shows on the glove natural without any of the working parts and members.

FIG. 6A Show a completed invention with all it's detailed and detailing.

FIG. 7 Is located on fig no 4 diagram page the glove can be used for smaller hands such as children, with a parent or guardian supervising.

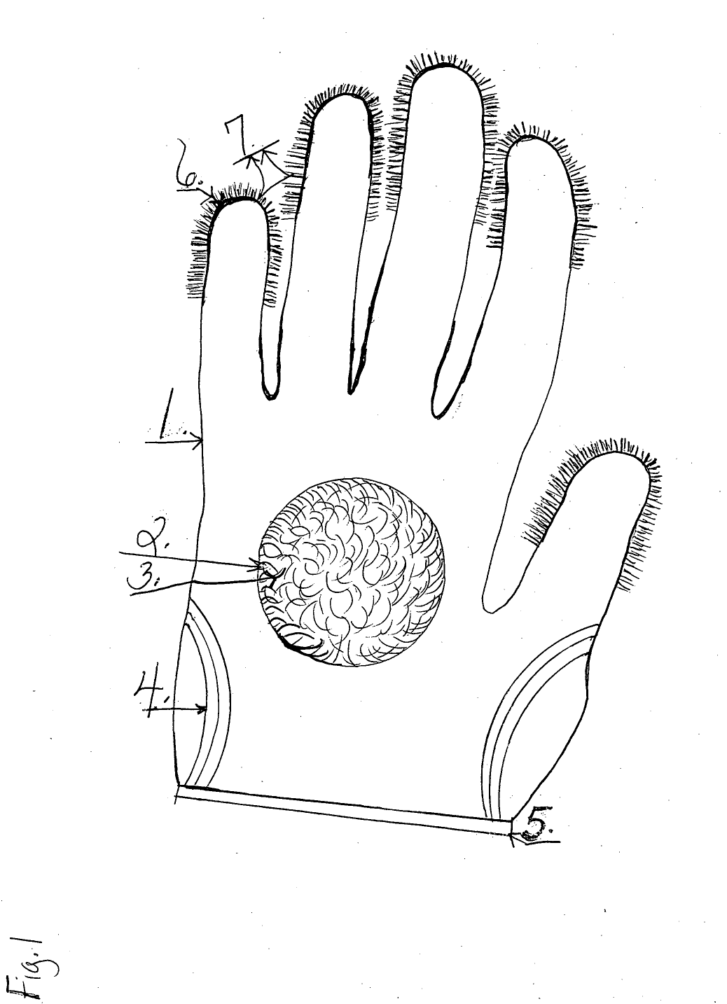

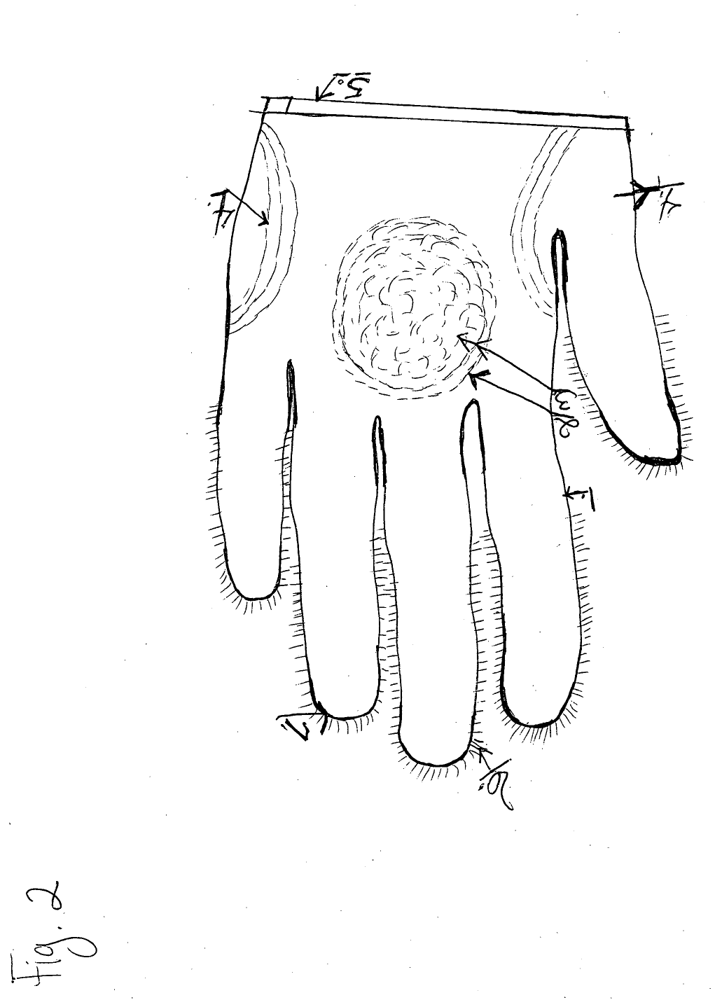

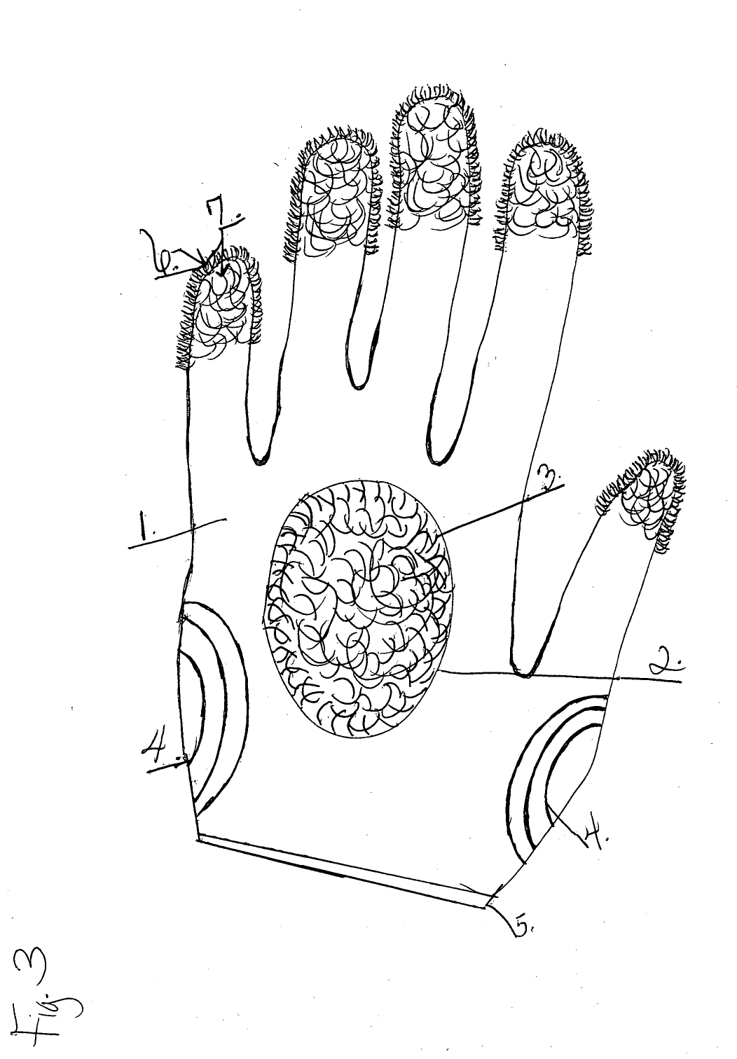

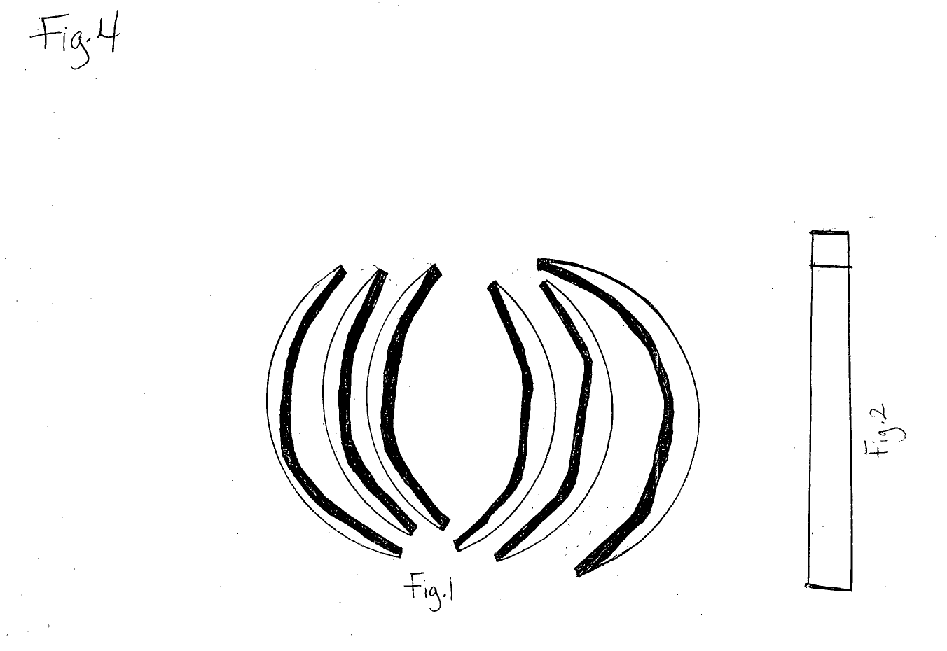

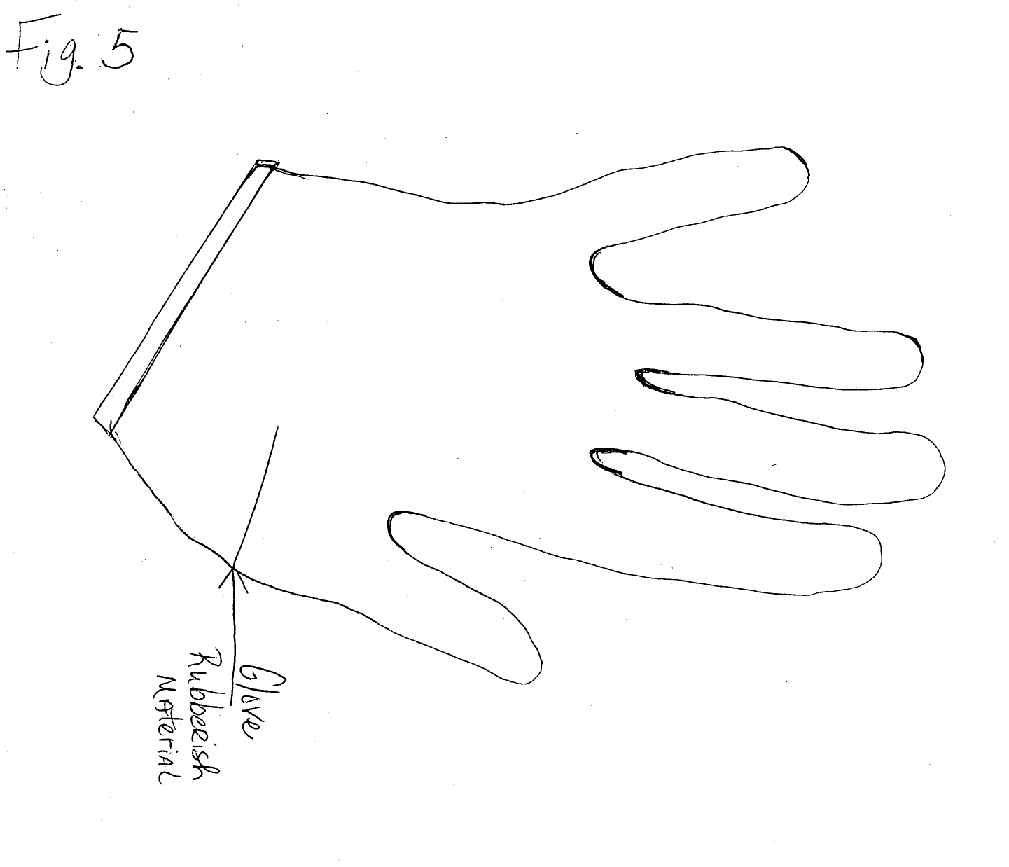

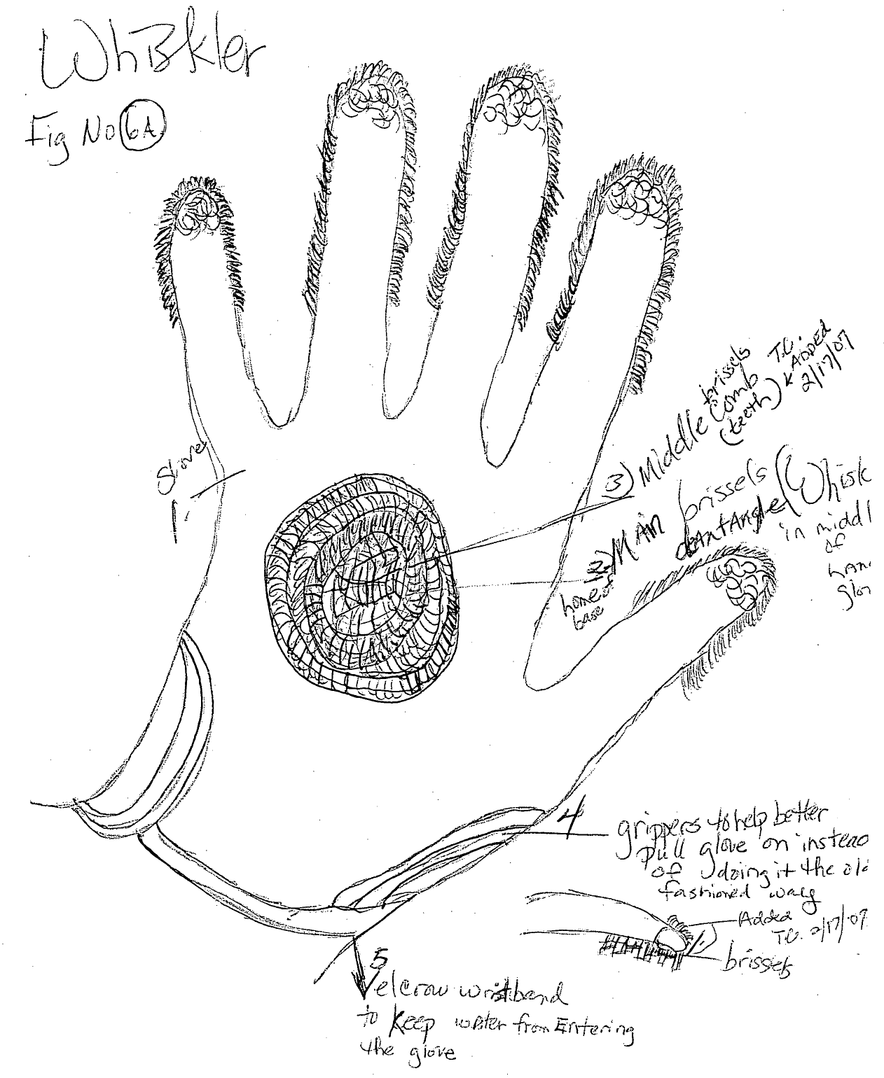

### PURPOSE OF THE PRODUCT AND ADVANTAGES

1. Its main purpose is to be a product that is a great help to mankind animals in the zoo, pets. Help with germs and getting pestilence, dyes, hair glues, dandruff etc., from the scalp.
2. The product protects fingernails from becoming brittle when washing pets or human hair.
3. We as Americans believe in fighting germs and again the product (whiskler) will be great in protecting your nails and hands from lice, fungi, pestilence, and many more germs we don't know about and they are out there.

### ADVANTAGES

1. The first advantage is no more messy brushes and combs you can yourself save a lot of money with this product. And save yourself from the germs of this world. I really need this product myself.

### CONCLUSION

I truly believe that if this product made correctly by the right manufacturers who care about quality, performance, durability it will do just what the purpose, drawings history and descriptions says.

I am a consumer, the main thing consumers want is a product that does what it says it will. I hope and pray that my fellow neighbors and Americans will enjoy this product.

We as Americans are very concerned about those germs out there the first thing when meeting people the first thing we recognize is your hair, eyes, teeth, hands and nails.

The whiskler Glove is a glove that can be considered the ambassador of gloves ambassador meaning highest rank in saying that it will be the highest glove in America. Salons, Pet owners, all over this beautiful nation will want this product. I truly believe it. And it has many purposes for its use.

What I claim as my invention: An Article Apparel which comprises:

1. A rubberish glove that has many hair duties and purposes.

2. It has members such as brissels which are imbedded on the fingertips and center and side of the fingertips. Brissels are in the center (palm) of the glove also; which perform detanglement and massage hair procedures.

3. A glove brush which brushes through hairs like a brush, but have teeth (brissels) similar to a miniature comb.

4. The glove exterior and interior material is rubberish the brissels will be rubberish as well.

5. Then there is the grippers which are six stripes of hard rubber that are added to help put or pull the glove on hand correctly. They are located on the left side to the right beneath the (main brissels) center (palm) home base.

6. The Velcro wrist band is added to help all unwanted germs, substances, water, chemical etc. from entering inside the glove as you perform all types of hair procedures.

7. Each Member of the glove is to perform a specific way, when (whisking) or grooming, styling, hairs either human or pet the apparel which is embellish will provide a unique performance for all hair types. When using the Whiskler glove just knowing that it is a genuine protector, makes it a special hair innovation for this Nation's changing hair products.
